(19) United States
(12) Patent Application Publication
(10) Pub. No.: US 2012/0078413 A1
(43) Pub. Date: Mar. 29, 2012

(54) SECURED ELECTRICAL RECHARGING FACILITY METHOD AND APPARATUS

(76) Inventor: Therman A. Baker, JR., Washington, DC (US)

(21) Appl. No.: 13/247,519

(22) Filed: Sep. 28, 2011

Related U.S. Application Data
(60) Provisional application No. 61/387,818, filed on Sep. 29, 2010.

(51) Int. Cl. G06F 17/00

(52) U.S. Cl. 700/232

(57) ABSTRACT

An electrical device recharging facility and method of operating the same is disclosed in which the facility includes a number of storage units having a locking mechanism operated according to a security access system and a number of power outlets and/or power cords arranged within the storage unit for recharging an electrical device.

### CROSS-REFERENCE TO RELATED APPLICATIONS

This application claims the benefit of U.S. provisional application 61/387,818, filed on Sep. 29, 2010, the subject matter of which is incorporated herein by reference in its entirety.

### BACKGROUND

The present disclosure generally relates to electrical recharging facilities and methods of operating the same.

In today's world, individuals have become accustomed to carrying and using a wide range of electronic devices during their daily routine, business travel or vacationing. These electronic devices include: cell phones; PDAs; laptops; mp3 players; portable DVDs/TVs/Radios; DS games; cameras and camcorders; iPads, notebooks and eBooks. As such, individuals have grown dependent upon locating and accessing, when needed, electrical power connections for purposes of operating devices or recharging batteries. Ordinarily, people can recharge their batteries in many venues by using “conveniently accessible” electrical power connections (i.e., found in residential, automobile, commercial or other public-friendly locations). To date, the marketplace is offering customers a variety of accessories to charge their batteries once a power source has been found (i.e., chargers designed for alternating current (“A/C”) and direct current (“D/C”) connections and USB ports, etc.).

However, when electrical power connections are not conveniently accessible, customers still encounter substantial difficulty with: (i) finding an electrical power source (for one or more devices); (ii) recharging their batteries for as long as desired; and/or (iii) being able to leave devices, while being charged, to engage in other activities (due to fear of theft and/or invasion of privacy).

The marketplace has a number of storage lockers (usually found in gymnasiums, workplaces, hotels/spas, etc.) where individuals can open, without charge, lockers and store personal items. Typically, individuals bring their own locks to use on the lockers.

The marketplace also has a number of vending machines (soda, candy, coffee, etc.) in which individuals will insert currency (whether cash or credit/debit) and, upon acceptance of cash, the machine will dispense products.

There are a number of “Electronic Lockers” on the market that perform both vending machine and storage functions. For many years, there have been rental storage lockers in public venues (i.e., currently found in amusement and water parks, and prior to “9/11” in various transportation centers). These storage lockers allow customers to insert currency into a slot in exchange for a key that opens a locker—thereby enabling customers to store and lock personal items. When using “key” lockers, the customer is required to pay in order to dislodge the key from the locker.

The marketplace has produced a variety of accessories that enable customers to draw electricity from power connections in order to recharge their batteries. For example, when using these accessories, customers are able to recharge their batteries using power cords/chargers to plug into (i) A/C power connections, (ii) D/C power connections, and (iii) USB ports on desktops.

There is an existing machine on the market that performs both vending machine and electrical recharge functions. This machine is marketed by Smarte Carte as the “Charge Carte” rapid charger. See http://www.smartecarte.com/rapid-charger. Specifically, this machine is designed to allow customers to recharge certain electronic devices by plugging them into any of the machine's twelve (12) power cords. The Charge Carte is limited in application to charging select cell phones, smartphones and IPods. This machine operates by (i) accepting cashless payments from customers, (ii) enabling customers to place their devices on unsecured open shelves, and (iii) allowing customers to use, to the extent compatible with their devices, one of the machine's twelve power plugs for recharging. The Charge Carte is relatively limited in benefits by (i) offering a thirty (30) minute charge cycle, (ii) recharging only those electronic devices which are compatible with the machine's twelve built-in power cords, and (iii) providing unsecured open shelves to hold devices and, thereby, requiring customers to continuously guard their devices from theft.

Over the years, rental storage lockers have been improved to facilitate cashless transactions and keyless access. More specifically, there currently are electronic lockers that (i) enable customers to interface with computer processing units in multiple languages, (ii) accept payments from customers, (iii) enable customers to gain keyless access to storage lockers via RFID chip technology (wristbands), PIN codes, Bar Code access, Smart Cards, and/or biometric technology (fingerprint scan), and (iv) provide a computerized security management system that monitors locker activity, maximize security and reduce locker maintenance. Typically, the customer pays for the amount of time that the locker is being used. One example of an electronic locker on the market today is Smarte Locke Electronic Lockers. Currently, the company that makes the Smarte Locke Electronic Lockers, Smarte Carte, has two electronic lockers which are marketed as its 1000 series and 3000 series lockers. See http://www.smartecarte.com/storage-lockers. Another example of an electronic locker is Excelsior Electronic Lockers. Currently, the company that makes the Excelsior Electronic Lockers, Excelsior Metal Products, LLC, manufactures a number of standard and custom made electronic lockers. See http://www.excelsiorlockers.com/electroniclockers.html. Yet another example of an electronic locker is Tiburon Electronic Lockers. Currently, the company that manufactures Tiburon Electronic Lockers, Tiburon Lockers, has several forms of electronic lockers. See http://www.tiburonlockers.com/storage-solutions/electronic-lockers.php. See also U.S. Pat. Nos. 4,383,210, 55,423,407, 5,744,933, 5,812,643, 6,314,169, 6,466,658, 6,721,400, and 6,977,341, and US patent publications 2003/0141840, 2004/0190694, 2006/0182240, 2006/0182241, 2008/0072509, 2008/0140565, 2009/001446, the disclosures of which are incorporated herein by reference.

The present disclosure provides conveniently accessible power connections to customers, thereby enabling customers to recharge their electrical equipment without time restrictions or fear of theft/security.

### BRIEF DESCRIPTION OF THE DRAWINGS

FIGS. 1 through 4 are elevation side views of a secured electric charging facility according to a first exemplary embodiment.

FIG. 5 is a schematic cross section view taken along line V-V of FIG. 1.

FIG. 6 is view like FIG. 5 of the ad box module.

FIG. 7 is a schematic cross section view of a secured electric charging facility according to a second exemplary embodiment.

FIG. 8 is a perspective view of a secured electric charging facility according to a third exemplary embodiment.

FIG. 9 is a perspective view of a secured electric charging facility according to a fourth exemplary embodiment.

FIG. 10 is a perspective view of a secured electric charging facility according to a fifth exemplary embodiment.

FIG. 11 is a perspective view of a storage locker of the secured electric charging facility of FIG. 1.

### DETAILED DESCRIPTION

Described herein are various embodiments of a secured electrical recharging facility that provides customers access to a number of stacked storage units containing one or more electrical power connections which, in turn, enable customers to (i) recharge their electronic devices, and (ii) store such electronic devices away inside the storage units while recharging (and, if desired, for longer periods). The facility may be stationary or moveable, manned or unmanned, and may be referred to herein as a kiosk.

Various embodiment described herein may include three integrated components, including: (i) a storage component; (ii) a vending machine component; and (iii) an electrical recharging component. Each of the three integrated components may perform separate functions. The storage component may include one or more storage units that allow customers to place their electronic devices inside (together with any other personal items), and then close and lock the storage unit. In one embodiment, the storage units may be lockers. In various other embodiments, the storage units may be small binds or slide-out compartments that can be pulled out and closed. The vending machine component allows customers to interface with a computer processing unit that may accept a form of currency, solicit personal information, direct the customer to the next available locker, and provide a secured method for the customer to lock and later gain access to the storage unit. The electrical recharge component may enable the customer, once inside the locker, to access one or more electrical power connections—thereby enabling him to recharge his device's battery.

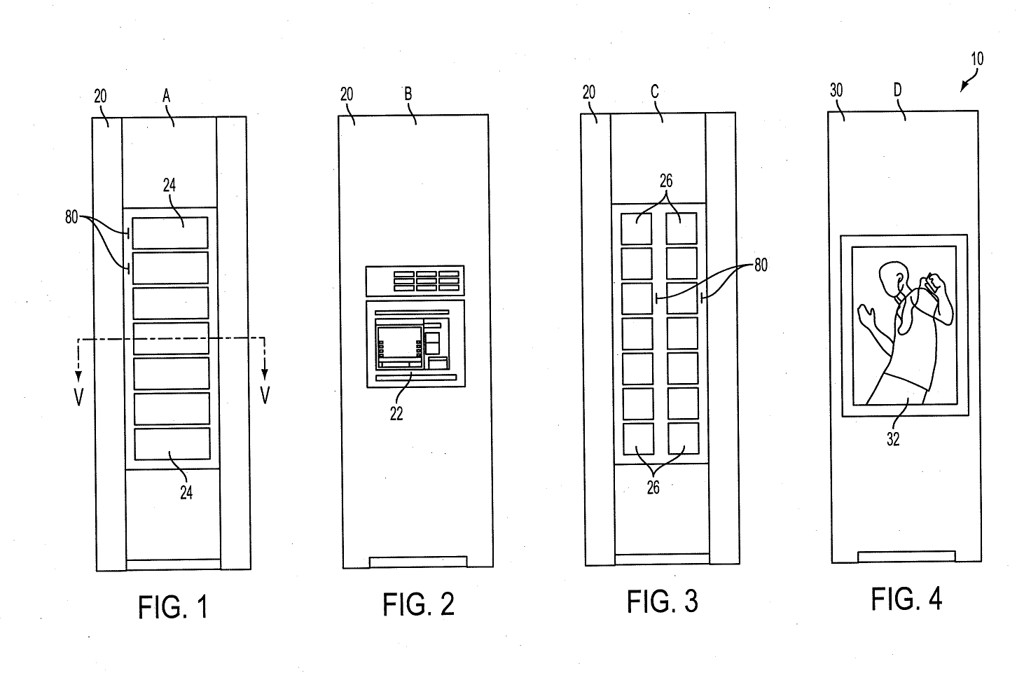

FIGS. 1 through 6 show a secured electric recharging facility 10 according to an exemplary embodiment. The facility 10 includes a storage module 20 and a removable display/ad box module 30. The facility 10 is configured as a tower, i.e., the facility 10 may be taller than it is wide, yielding a number of advantages. For example, the tower configuration helps minimize the actual use of floor space and maximize the number of storage units 24, 26. This may allow the facility 10 tower to more easily fit in congested areas, such as hallways, without being placed next to a wall in a remote location. The tower configuration also may extend higher to allow the customer to more easily see the kiosk in crowded environments. Also, the tower configuration raises the height of the lowest storage units 24, 26 so that, unlike most locker configurations, they are not at ground level, which prevents customers from having to bend low to access them. In other embodiments, the storage units 24, 26 may extend all the way to the floor to maximize the use of space. In still other embodiments, the facility may be wider than it is tall, for example, to fit into an otherwise unused space.

One or more fans 70 may be placed in the facility 10 to circulate air to disperse heat from and cool the facility 10. In one embodiment, the fan or fans may be arranged at the bottom of the facility 10 and blow air upwards. In other embodiments, the fan or fans may be arranged in different or additional locations. The components such as the unit 26 have air passages, schematically represented by holes 72, to allow adequate air movement for cooling. All or some of the walls and doors may have air passages as required for cooling. Air passages may not be needed in the doors and elimination of the holes from the doors may increase security for the device.

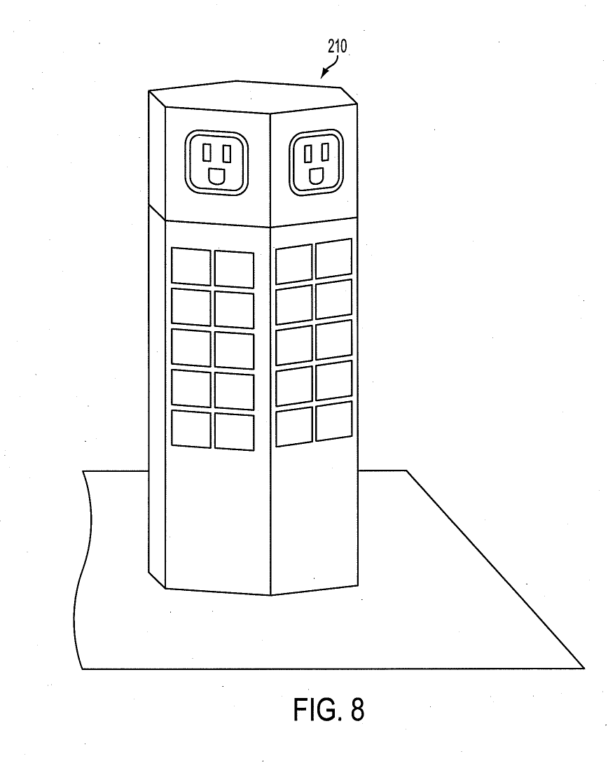

The facility 10, as shown in the embodiment of FIGS. 1-6, has four sides A, B, C, D. As shown in FIG. 1, the storage component includes seven stacked large storage units 24 arranged on side A, each appropriate to fit a large device, for example, a laptop. As shown in FIG. 3, fourteen stacked smaller storage units 26 are arranged on side C, each appropriate to fit one or more smaller devices, for example, cell phones, PDAs, tablet computers, mp3 players, portable DVDs/TVs/Radios, DS games, cameras and camcorders. In other embodiments, the facility 10 could have all large storage units 24 (7 in the front and 7 in the back, for a total of 14 storage units) or all small storage units 26 (14 in the front and 14 in the back, for a total of 28 storage units). It should be understood that the actual number of storage units 24, 26 and each storage unit's dimensions may vary based on, for example, pricing considerations, available space and market demands among other things. In other embodiments, the facility 10 and the storage units 24, 26 may be relatively larger or smaller to accommodate a smaller or greater number of storage units 24, 26 within the facility 10. In still other embodiments, the ratio of smaller storage units 26 to larger storage units 24 may be changed as desired. While the facility 10 shown in FIGS. 1-6 includes four sides A, B, C, D, other embodiments may include a facility having a different number of sides, for example, three, five, six, seven, or eight sides. FIG. 8, for example, shows a facility 210 that has six sides. In yet another embodiment, the facility may include two, three, four, five, six, seven, or eight curved sides that are fitted together to form a continuous or discontinuous curved outside wall, for example, a circle, an oval, or an irregular curved shape.

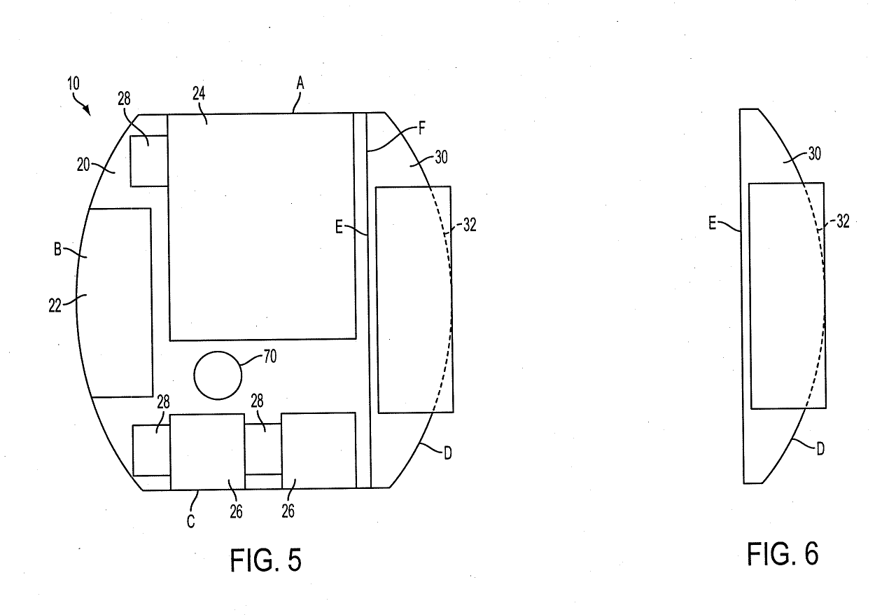

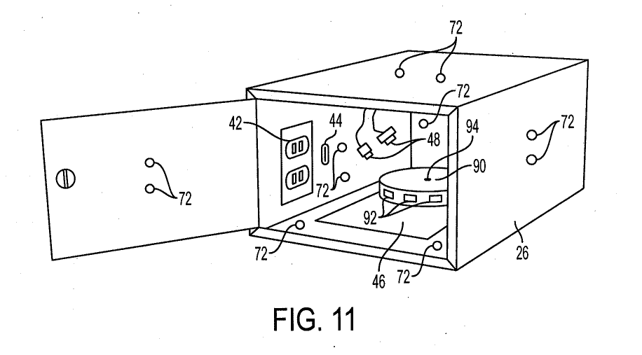

As shown in the schematic cross section of the facility 10 of FIG. 5, each storage unit 24, 26 is provided power through a power box 28. Each facility 10 may be equipped with a switchable power circuit that receives power from a power source and delivers power, after passing through surge protection circuits, to the power boxes 28. As shown in FIG. 11, each storage unit 24, 26 may include one, two, three or more A/C power connections 42 and/or USB ports 44. In various other embodiments, the storage units 24, 26 may also include additional electrical connections (not shown), for example, to accommodate D/C power chargers (cigarette lighters), and/or European style AC plugs. The storage units 24, 26 may also include one or more power cords, such as charging or power tips 48, adapted to charge specific electrical devices. Also, the power stations may be fitted with a wireless charging mat 46, for example, a powermat, available from Powermat USA, LLC, www.powermat.com, which will allow devices to be charged wirelessly. In addition, a rotating connector wheel 90 includes a number of connectors 92 which may be of various configurations for various types of devices to be charged. The wheel 90 is rotated about pivot 94 until the appropriate connector 92 is accessible and the device to be charged is plugged into the connector. The connectors 92 are removable and replaceable for repair and to accommodate updating the wheel 90 as additional device connection technologies come on the market. The facilities 10 are not limited to charging only cell phones or devices that are compatible with the various power cords 48. Instead, the facilities may charge all devices as long as the customer has a power charger that may plug into one of the A/C 42, D/C, or USB power connections 44, or is chargeable with a power mat.

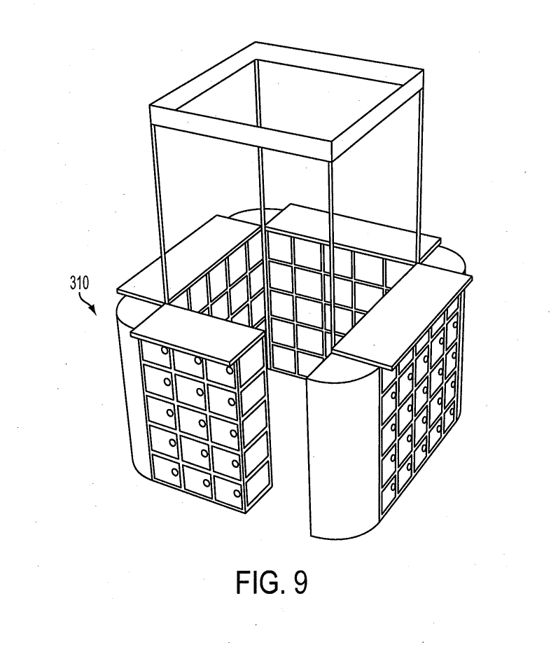

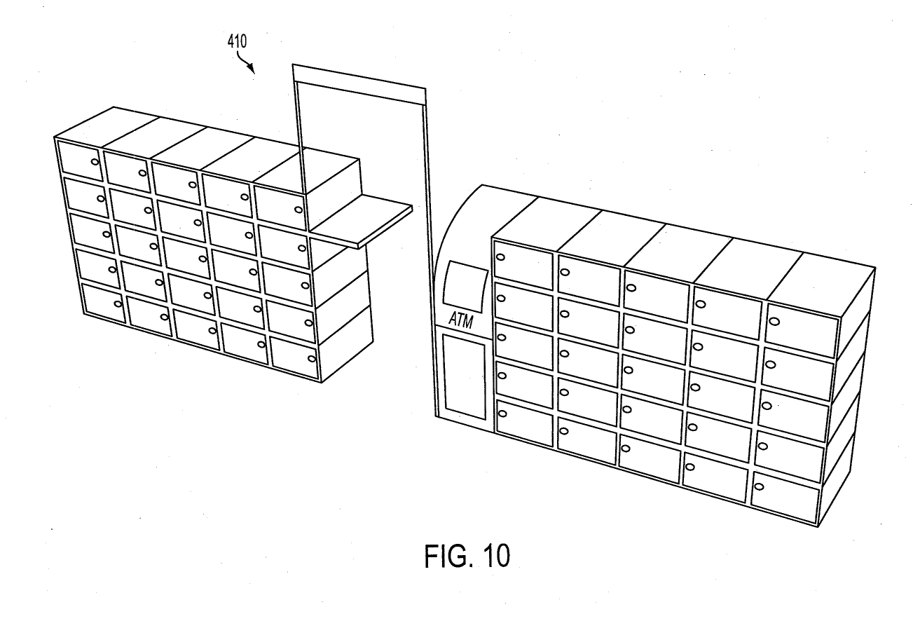

In the embodiment shown in FIGS. 1-7, the facility 10 is self automated. However, as shown with respect to the facilities 310, 410 in the embodiments of FIGS. 9 and 10, respectively, a person (“attendant”) may be available to sell accessories, assist customers with interfacing with the payment box 22, as well as maintenance and/or troubleshooting of the facility 10. An attendant may be used with any of the illustrated embodiments.

The facility 10 may also include one or more of the following features:

a. Magtek encrypted card acceptors, e.g., credit card swipers;

b. Bill and/or coin acceptors, for example Mars® Bill acceptors, to accept cash payments;

c. Remote interrogation to allow a corporate office to remotely determine if storage units are being used, detect malfunctions, and the storage units to be remotely opened;

d. Touch screens;

e. Two way communication;

f. Wireless internet to allow the tower to process payments and communicate with corporate offices, in addition to or in lieu of a hardline connection to the internet.

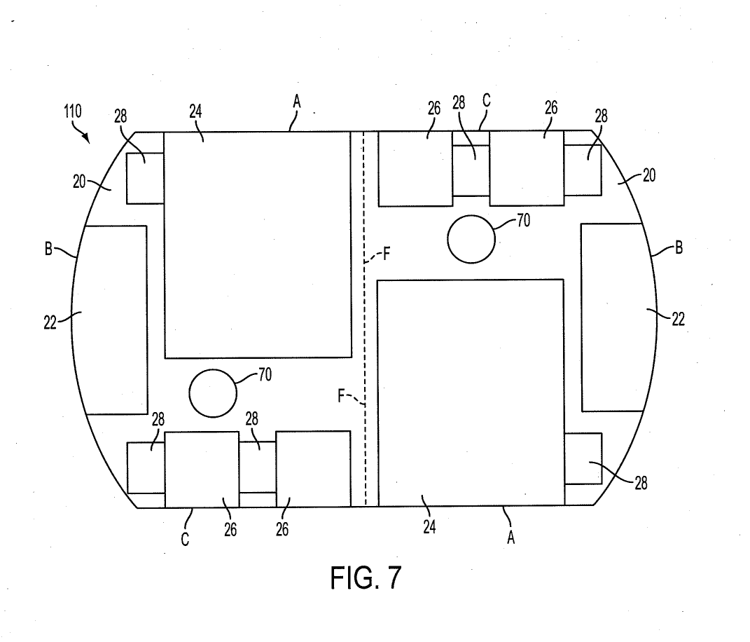

The power station module 20 of facility 10 has a fourth side wall F that may provide one or more of a number of functions. For example, the side wall F may connect to sidewall E of an advertising module 30 that may include an advertisement sign or signs 32. The advertising module 30 may also include an additional payment box 22 in addition to or instead of signs 32. As shown in FIG. 6, the advertising module 30 may be removable from the power station module 20. The side wall F may include connectors which may provide electricity to the advertising module 30, which may have, for example, LCD lights behind it. The side wall F may serve as a wall for other purposes as well. For example, a vending machine may be affixed to and draw electricity from the side wall F and may sell, for example, electronic device accessories. Or, as shown in FIG. 7, the side wall F may back up to or interlock with another facility 11 to increase the number of storage units. The two adjoining facilities 10, 11 may communicate with each other so that each computer processing unit 22 may serve all of the storage units 26, 24 of the combined facility 110.

A payment box 22 may be accessible to customers on at least one of the sides A, B, C, D of the facility 10. The payment box 22 may include one or more of a payment acceptor, a video display, and a user input device. The functions of the payment box 22 and storage units 24, 26 may be controlled by a computer processing unit. The computer processing unit may be a computer processor located locally within the facility as part of the payment box 22, elsewhere within the facility, or remotely from the facility. The computer processing unit may interface with customers by collecting personal information, accepting currency, and allowing the storage units 24, 26 to be accessed.

In one embodiment, the facility 10 can be adapted with solar panels or other power generators (not shown), which will allow for the facility 10 to receive electricity to charge devices in outdoor locations without using electrical hook-up.

In operation of the facilities, the customer will approach a facility 10 and may be greeted by an attendant, and/or the customer will interface with the payment box 22. The payment box 22 may include a video display that will provide instructions on how the storage units 24, 26 may be accessed and their associated cost of rental. The video display may be in the form of a touch-screen, such that a customer can make his selections by pressing points on the display. Alternatively, the payment box 22 may include a user input device for the customer to access, which may be, for example, a keyboard, mouse, stylus, keypad, or other device capable of inputting information into the computer processing unit 22.

Using the payment box 22, the customer may then instruct the computer processing unit on how many lockers he would like to use and his form of payment, for example, cash, credit, or debit. The customer may provide payment by use of a payment acceptor, which may accept payment by coin, bill, and/or credit/debit card. The payment acceptor may also include a device for electronic detection of a source of credit or money, such as a credit card or a device with a barcode or RFID tag.

After the customer's form of payment has been approved, the customer may review and affirmatively make certain waivers and accept certain disclaimers, for example, concerning damage liability and safety concerns, and provide certain customer information, for example, address, contact information, password, etc. Alternatively, the attendant may collect and process certain information for the customer.

In one embodiment, once the customer's information has been entered into the system, it may be stored and his subsequent visits to a facility 10 may require less interfacing with the computer processing unit. In one embodiment, following his first use, the customer may be issued a smart card which, in turn, will enable him to be more quickly processed by the computer processing unit, including debits/credit payment processing.

In various embodiments and depending on the particular facility's 10 security access system, the computer processing unit may then identify an available storage unit 24, 26 and direct the customer to the appropriate storage unit. Each storage unit 24, 26 may include a door having a locking mechanism to prevent unauthorized access of the storage unit. The locking mechanism may be operated according to a security access system. Security access systems to access the storage units 24, 26 may include:

i. PIN Access, in which customers provide the computer processing unit with a PIN number or password;

ii. Bar Code Access, in which customers are issued a bar code by the computer that, when placed against a sensor, will enable a locker to open;

iii. RFID Access, in which customers are issued a wristband or card that, when placed against a sensor, will enable a locker to open;

iv. Biometric Access, in which a scanner records the customer's fingerprint and subsequently allows the customer to gain access to the locker;

v. Smart Card, in which customers may be issued a smart card that, when placed against a sensor, will enable a locker to open; and/or

vi. Drivers License, many drivers licenses are bar-coded and may be used to verify identity;

vii. Credit Card Access in which customers may use a credit card or debit card that when placed or swiped in a reader, will enable a locker to open for the user to gain access.

In one embodiment, the storage units 24, 26 can be accessed by customers simply by use of their credit card at a payment box 22. In one embodiment, a customer swipes the credit card to open the locker at the beginning of the transaction to open a particular storage unit, and the kiosk facility 10 remembers the card so the customer may use the same card to reopen the storage unit. In the illustrated embodiment, an express card reader 80 is located next to the units 24, 26 so that the user may reopen the unit even while the payment box 22 is in use by other customers. Also, the express reader 80 provides additional security because it allows the user to access the unit immediately when it reopens without having to first move along or around the kiosk 10, even if the reopened unit is on the other side of the kiosk 10. Although only a few readers 80 are shown in the drawings, readers 80 may be located at all or any number of the units 24, 26.

The kiosk recharging facilities described herein may have the security access features described above, but may have, in addition or alternatively to the security access features, an attendant to manually lock away items, for example, at locations where a variety of other items may also be stored, such as at beaches. Upon gaining access to a storage unit 24, 26, the customer can plug an electronic device into the locker's “A/C” power connection using his own power cord. In various other embodiments, the customer may use his power charger to access a “D/C” power connection or “USB” port connection. In various embodiments, if the customer does not have his own power cord, he may use the provided charging or power tips in the unit or purchase or rent one, or an adaptor/converter, from the attendant.

The Customer may then close the locker door to effectively lock his items inside. Alternatively, an attendant may manually lock away items. In various embodiments, the facility may have indicators, such as computer monitors, that may inform customers as to the amount of time that lockers have been occupied. In various embodiments, the fee may be based upon the length of time that a locker is being used.

Depending upon the Recharging Facility's security access system, the customer may, upon return, gain access to his locker using one or more of the methods described above, for example, by using a PIN number, an issued bar code, an RFID access device, biometric access, and Smart Card access. Kiosk Units may alternatively require an attendant to manually unlock a locker to retrieve items. If the customer encounters difficulty with opening his locker, he can engage the attendant who will then confirm the customer, through some method including passwords and/or identification, and open the storage unit 24, 26. Once the storage unit 24, 26 has been emptied, the computer processing unit may switch off power to the empty storage unit.

Each facility 10 may be operated locally by a facility manager. In addition, a number of remotely located facilities 10 may be monitored and supervised remotely by a Central Management Unit (“CMU”). Each facility's computer processing unit 22 may be directly connected to a central computer system supervised by the CMU so that all processed payments may be recorded and deposited into a designated CMU bank account. Also, each facility's computer processing unit may provide the CMU's computer system, as well as the Facility Manager, with information such as, a log containing the amount of usage for each storage unit, the generated revenue for each storage unit, the next scheduled maintenance visit for the facility, as well as any security/malfunctioning concerns. In addition, the central computer system may transfer periodically to each facility's computer processing unit new data, such as updated operating procedures and new rental rates.

In the embodiment shown in FIG. 10, the secured electrical recharging facility 410 is intended to be a stationary recharging facility, i.e., operated as a stationary permanent fixture located, for example, in highly trafficked locations such as airport terminals. The recharging facilities may be constructed from heavy materials, such as metal, and may be arranged as a stacked number of electronic storage units, for example, lockers, which, as shown in the embodiment of FIG. 10, may be arranged in five adjoining columns, with each column containing five lockers. In other embodiments, the storage units may be arranged in other configurations as desired, including a lesser or greater number of columns, with a lesser or greater number of storage units in each column. In other embodiments, the facilities may include any combination of large and small units or all large units or all small units or other sizes. In other embodiments, each wall of the facilities may include any combination of large and small units or all large units or all small units or other sizes, and may include a payment box.

In the embodiment shown in FIG. 9, the kiosk recharging facility 310 is intended to be operated in highly trafficked venues where a stationary recharging facility may not be feasible, e.g., it is not cost effective or there is insufficient space. The kiosk recharging facilities may be much smaller structures designed to accommodate smaller electronic devices. These facilities are portable and may contain either a switchable power circuit that receives power from an A/C power source or, alternatively, may contain a self contained power generator. Such power will pass through a surge protection circuit prior to being delivered to a customer's electronic device.

The recharging facilities described herein may be constructed on wheel carts and may contain on each side of the cart a stacked number of storage units which, as shown in the embodiment of FIG. 9, may be arranged in five adjoining columns, with each column containing five lockers. In other embodiments, the storage units may be arranged in other configurations as desired, including a lesser or greater number of columns, with a lesser or greater number of storage units in each column. The storage units may be connected to one or more computer processing units housed on the cart. The computer processing units may interface with customers by collecting personal information, accepting currency, and allowing the storage units to be accessed. The actual number of lockers and each locker's dimensions may vary based on pricing considerations and market demands.

The disclosed embodiments described herein serve as a vending machine for electricity which, in turn, enables customers to secure their electronic devices in storage units while the electronic devices are being recharged. While there are plenty of ways that people may recharge the batteries of their electronic devices, exemplary benefits of the embodiments described herein include:

1. More conveniently accessible power connections in places where power sources may be scarce;

2. Providing customers with the ability to charge and store their electronic devices for as long as desired;

3. Providing customers with the peace of mind to leave such devices in electronic lockers and engage in other activities away from such devices without fear of theft or invasion of privacy.

In addition, at the facility 10, customers may be able to purchase a wide range of accessories including: power cords, adaptors for various power sources, foreign voltage converters, quick battery boosters, rapid charge cords, and replacement batteries. The facilities 10 also may serve as Electronic Lockers—storage lockers that do not require a manual key to open, and which may include any of the above referenced security access systems: PIN Access; Bar Code Access; RFID chip technology (on wristbands or cards); Biometric access; Smart Card; credit card access; drivers license access; and/or password access. The disclosed embodiments differentiate from the prior art discussed above, such as the Charge Carte, by, among other things, (i) offering customers a power connection (instead of select power cords) that will service an open universe of electronic devices, (ii) not proscribing a time limit on a charge cycle (thereby eliminating the need for customers to return to the machine every 30 minutes), and (iii) allowing customers to secure their electronic devices in lockers.

The above description and drawings are only to be considered illustrative of specific embodiments, which achieve the features and advantages described herein. Modifications and substitutions for specific conditions and materials can be made. Accordingly, the embodiments are not considered as being limited by the foregoing description and drawings, but is only limited by the scope of the appended claims.

What is claimed as new and desired to be protected by Letters Patent of the United States is:

1. An electrical device recharging facility, comprising:
a first side, a second side, and a third side, wherein each of the first, second, third sides are accessible by a customer;
a first plurality of storage units accessible to the customer from the first side and a second plurality of storage units accessible to the customer from the second side, the storage units comprising:
a door comprising a locking mechanism operated according to a security access system, and
at least one of an alternating current outlet, a direct current outlet, a USB port, and a plurality of power cords adapted for interfacing with a plurality of electrical devices;
a payment box accessible to the customer from the third side, the computer processing unit comprising:
a user interface by which the customer may communicate with the computer processing unit,
a display device by which the computer processing unit may provide a message to the customer, and
a payment acceptor, by which the customer may make a payment; and
a computer processing unit that activates the security access system to allow the customer to access a storage unit after receiving payment by the payment acceptance mechanism.

2. The electrical device recharging facility of claim 1, wherein the storage units are lockers.

3. The electrical device recharging facility of claim 1, further comprising a fourth side and a removable display module connected to the fourth side.

4. The electrical device recharging facility of claim 1, wherein the facility is taller than it is wide.

5. The electrical device recharging facility of claim 1, further comprising a fan to circulate air throughout the facility to disperse heat from the facility.

6. The electrical device recharging facility of claim 1, wherein the first plurality of storage units are smaller than the second plurality of storage units.

7. The electrical device recharging facility of claim 1, wherein the first plurality of storage units are sized such that they will accommodate cell phones, PDAs, and mp3 players, and wherein the second plurality of storage units are sized such that they will accommodate laptop computers.

8. The electrical device recharging facility of claim 1, wherein the first plurality of storage units are the same size as the second plurality of storage units.

9. The electrical device recharging facility of claim 1, further comprising a fifth side and a sixth side.

10. The electrical device recharging facility of claim 1, further comprising a plurality of power boxes that provide power to the first plurality of storage units and the second plurality of storage units.

11. The electrical device recharging facility of claim 1, further comprising a switchable power circuit that receives power from a power source and delivers power to the storage units.

12. The electrical device recharging facility of claim 1, wherein each storage unit comprises at least two alternating current outlets.

13. The electrical device recharging facility of claim 1, wherein the storage units further comprise USB ports.

14. The electrical device recharging facility of claim 1, wherein the storage units further comprise wireless charging mats.

15. The electrical device recharging facility of claim 1, wherein the payment acceptor comprises one or more of a coin acceptor, a bill acceptor, and a credit/debit card reader.

16. The electrical device recharging facility of claim 1, further comprising a vending machine for dispensing electronic device accessories, the vending machine being connected to the fourth side.

17. The electrical device recharging facility of claim 1, wherein the user interface and the display device comprise a touch-screen.

18. The electrical device recharging facility of claim 1, wherein the security access system may be accessed by use of one or more of a PIN number, a bar code, an RFID, biometric data, and a smart card.

19. The electrical device recharging facility of claim 1, wherein the first side, second side, and third side are curved and are fitted together to form a continuous curved outside wall.

20. A method of operating an electrical device recharging facility, comprising:
receiving, at a computer processing unit, a request for access to a storage unit, the request being input through a payment box arranged on a first side of the facility;
receiving notification of payment at the computer processing unit, the payment being input through a payment acceptor;
activating a security access system a first time to allow a customer to access a selected storage unit of a plurality of storage units arranged on a second side and a third side of the facility, the security access system being activated by the computer processing unit; and
providing power to at least one of an alternating current outlet, a direct current outlet, a USB port, and a plurality of power cords adapted for interfacing with a plurality of electrical devices arranged inside the selected storage unit.

21. The method of claim 20, wherein the payment acceptor comprises one or more of a coin acceptor, a bill acceptor, and a credit/debit card reader.

22. The method of claim 20, further comprising receiving a customer's personal information at the computer processing unit, the personal information being input through the user interface.

23. The method of claim 22, further comprising storing the customer's personal information and accessing the customer's personal information when the customer accesses the facility a second time.

24. The method of claim 20, further comprising receiving a notice of an affirmative waiver of liability at the computer processing unit, the affirmative waiver of liability being input through the user interface.

25. The method of claim 20, further comprising identifying the selected storage unit to a customer using a display device.

26. The method of claim 20, further comprising activating the security access system a second time to allow a customer to access the selected storage unit upon receiving one or more of a required PIN number, bar code, RFID signal, biometric data, credit card, drivers license, password and smart card input.

27. The method of claim 20, further comprising activating the security access system a second time to allow a customer to access the selected storage unit upon receiving information from a credit card used to provide payment.

28. The method of claim 20, further comprising providing information to a customer as to the amount of time that the selected storage unit has been occupied.

29. The method of claim 20, wherein the amount of payment due is based upon the length of time that the selected storage unit is used.

30. The method of claim 20, further comprising cutting power to the least one alternating current outlet and the plurality of power cords adapted for interfacing with a plurality of electrical devices arranged inside the selected storage unit after activating the security access system a second time to allow the customer to access a selected storage unit.

31. An electrical device recharging facility tower, comprising:
a plurality of sides, at least two of the plurality of sides being accessible to a customer, wherein at least two of the plurality of sides includes at least one of:
a payment box, and
a plurality of storage units, wherein the plurality of storage units comprise:
a locking mechanism operated according to a security access system, and
at charging outlet adapted for charging an electrical device; and
the tower further comprising a computer processing unit that activates the security access system to allow the customer to access a storage unit.

32. The electrical device recharging facility tower of claim 31, wherein the plurality of sides are curved and are fitted together to form a continuous curved outside wall of the tower.

33. The electrical device recharging facility tower of claim 31, wherein the payment box comprises:
a user interface by which the customer may communicate with the computer processing unit;
a display device by which the computer processing unit may provide a message to the customer; and
a payment acceptor, by which the customer may make a payment.

34. The electrical device recharging facility tower of claim 31, further comprising a removable display module connected to one of the plurality of sides.

35. The electrical device recharging facility tower of claim 31, further comprising a first plurality of storage units and a second plurality of storage units, wherein the first plurality of storage units are smaller than the second plurality of storage units.

36. The electrical device recharging facility tower of claim 35, wherein the first plurality of storage units are sized such that they will accommodate cell phones, PDAs, and mp3 players, and wherein the second plurality of storage units are sized such that they will accommodate laptop computers.

37. The electrical device recharging facility tower of claim 35, wherein the first plurality of storage units are arranged on a first side of the tower and wherein the second plurality of storage units are arranged on a second side of the tower.

38. The electrical device recharging facility tower of claim 31, further comprising a plurality of power boxes that provide power to the first plurality of storage units and the second plurality of storage units.

39. The electrical device recharging facility tower of claim 31, wherein said charging outlet includes at least one of an alternating current outlet, a direct current outlet, a power cord adapted for charging an electrical device, and a USB outlet.

40. The electrical device recharging facility tower of claim 31, wherein the payment acceptor comprises one or more of a coin acceptor, a bill acceptor, and a credit/debit card reader.

41. The electrical device recharging facility tower of claim 33, wherein the user interface and the display device comprise a touch-screen.

42. The electrical device recharging facility tower of claim 31, wherein the security access system may be accessed by use of one or more of a PIN number, a bar code, an RFID, biometric data, credit card, drivers license, password and a smart card.

43. The electrical device recharging facility tower of claim 31, wherein the plurality of sides form a continuous outside wall of the tower and each side is accessible to a customer.
